(19) United States
(12) Patent Application Publication
(10) Pub. No.: US 2016/0159582 A1
(43) Pub. Date: Jun. 9, 2016

(54) CONVEYOR SYSTEM FOR TRANSPORTING ITEMS

(71) Applicant: CRISPLANT A/S, Aarhus N (DK)

(72) Inventor: Anders Bentsen, Viby J (DK)

(73) Assignee: Crisplant A/S, Aarhus N (DK)

(21) Appl. No.: 14/906,825

(22) PCT Filed: Jul. 25, 2013
(86) PCT No.: PCT/DK2013/050252

§ 371 Date: Jan. 21, 2016

(51) Int. Cl. B65G 47/57; B65G 15/62

(52) U.S. Cl. CPC B65G 47/57; B65G 15/62

(57) ABSTRACT

The invention relates to a conveyor system (1) for transporting items (104) in a conveying direction (P) and comprising a first conveyor section (100), a second conveyor section (102), and a frame (F) below said second conveyor section (102), said first conveyor section (100) and said second conveyor section (102) each defining a conveying surface for engaging a bottom surface (108) of said items (104) and for forward movement of said items (104) along said conveying direction (P), said first conveyor section (100) being adapted to deliver one or more of said items (104) to an item transition region (T) of said second conveyor section (102), said second conveyor section (102) including: at least one conveyor belt (180) defining said conveying surface of said second conveyor (102), and a shock-absorbing device (160) mounted to said frame (F) in said item transition region (T), characterised in said shock-absorbing device (160) having an upper face (182) located below said at least one conveyor belt (180) and facing said conveyor belt (180), said shock-absorbing device (160) being for providing a controlled vertical deceleration of said items (104) in said transition region (T) by said conveyor belt (180) being pressed against said upper face (182) by impact applied by said items (104) onto said conveyor belt (180) in said transition region (T).

### TECHNICAL FIELD

The present invention relates to a conveyor system, in particular a conveyor system in which items are transported by means of belt conveyors, the items being optionally transported in totes. The invention is of particular use for controlling impact from such items transported between two conveyor sections which may be arranged with an angle with respect to one another or at different levels.

### BACKGROUND OF THE INVENTION

WO 99/30993 discloses a conveyor system for transporting items in a conveying direction and comprising individual belt conveyor sections along which items are conveyed in totes. A first conveyor section is adapted to deliver one or more of the item(s) to a second conveyor section, the first and second conveyor sections each defining a conveying surface for supporting the items. In a practical application of the conveyor system, two consecutive conveyor sections may define a mutual angle in a vertical plane extending in parallel to the conveying direction, so that a transition is defined between the first and second conveyor section. Some dampening of the movement of the items passing to the second conveyor section will be provided by the items itself and by the first and/or second conveyor section. However, it has been found that this dampening is usually not sufficient in order to limit wear on the items and on the conveyor system, and it may not be sufficient to silence the conveyor system during operation, as impacts on the item and the conveyor sections may be severe.

DE 202 16 077 discloses a conveyor system of the type mentioned above which reduces the risk of items being damaged due to mechanical impact in the transition between the first and the second conveyor section by a shock-absorbing device for providing a controlled vertical deceleration of the item in the transition region between the first and the second conveyor section. The items act directly on the shock-absorbing device which provides a controlled vertical deceleration, by providing a dampening effect in addition to the dampening provided by the items themselves.

### SUMMARY OF THE INVENTION

It is an object of the present invention to provide a conveyor system of the type mentioned above which may be manufactured in an economical way with simple means, even allowing existing conveyor systems with no current efficient damping to be easily modified to provide such an efficient damping. This is achieved in that the shock-absorbing device has an upper face which is located below the at least one conveyor belt, facing the lower surface of the conveyor belt, the shock-absorbing device being configured to provide a controlled vertical deceleration of the items in the transition region by the conveyor belt being pressed against the upper face of the shock-absorbing device by the impact applied by the items onto the conveyor belt in the transition region. Where an initial pressure is already being applied by the conveyor belt as such, additional pressure is applied by the impact.

Preferably, the shock-absorbing device is configured as a block, such as an elongated block, of a resilient material which may optionally locally raise the conveyor belt a distance from beams that are part of a supporting frame, and the resilient material of the device may in that case be continuously held in a state of slight compression through the tension in the conveyor belt. The shock-absorbing device may alternatively be arranged to contact the conveyor belt only when a tote impacts the conveyor belt in the item transition region above the shock-absorbing device. In some embodiments the block of resilient material may have a surface portion providing a low frictional resistance against the belt running in contact therewith.

Preferably, the second conveyor includes at least two spaced apart parallel conveyor belts that define together the conveying surface of the second conveyor, with an elongated beam extending along with and below each of the conveyor belts, and towards impact as aforementioned is directed to temporarily reduce the height of the shock-absorbing device. A respective one of the shock-absorbing devices is preferably being mounted onto the top of each of the beams, by gluing, by screws or by similar means, in the item transition region and with the upper face thereof facing the corresponding conveyor belt, preferably with a continuous contact between the upper face of the shock-absorbing device and the conveyor belt.

The conveyor system according to the invention may comprise at least two, or even a plurality of conveyor sections arranged adjacent to each other in series. Thus, a conveyor system having a modular design may be built up of a number of conveyor sections.

The conveyor system may be installed, e.g., at airports, railway stations, ship departure halls, factories, production plants, mines or at other locations wherein the modular design of the conveyor system may be applied for obtaining a high conveying capacity. The conveyor system is usually arranged to convey items from, e.g., one airport, railway or ship terminal to another.

Each item may comprise a supporting member, such as, e.g., a tray, tote or a container carrying or containing one or more articles, such as, e.g., one or more pieces of luggage, factory products or other items. However, an item may comprise an article only, which is not supported by a supporting member.

### BRIEF DESCRIPTION OF THE DRAWINGS

Different embodiments of a conveyor system and a shock-absorbing device for a conveyor system according to the present invention are for illustration of the invention described below with reference to the accompanying drawings of which

FIGS. 1a and 1b show schematically a conveyor system viewed from the side, with an item in transit between two conveyor sections thereof,

FIG. 1c shows schematically an alternative embodiment of a conveyor system according to the invention,

FIG. 2 is a perspective view of an embodiment of the invention,

FIG. 3 is an enlarged view of a detail of FIG. 2,

FIG. 4 is a perspective view of an alternative embodiment of the invention,

FIG. 5 is an enlarged view of a detail of FIG. 4.

### DETAILED DESCRIPTION OF THE DRAWINGS

In the following description, items 104 are often referred to as totes. It should be 10 understood that the totes or items 104 referred to below may support articles, such as pieces of luggage, to be conveyed. In the embodiments of any of the drawings the articles need, however, not be supported by totes. Accordingly, in those embodiments, the totes illustrated in the drawing may be substituted by articles.

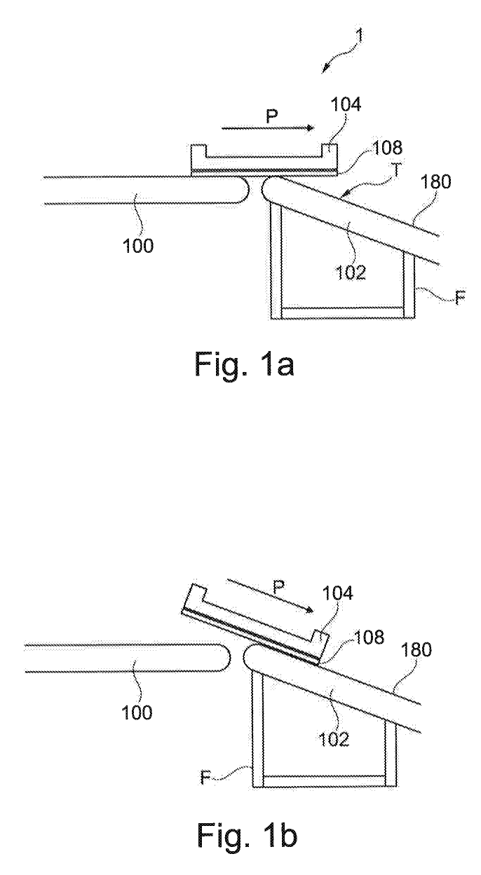

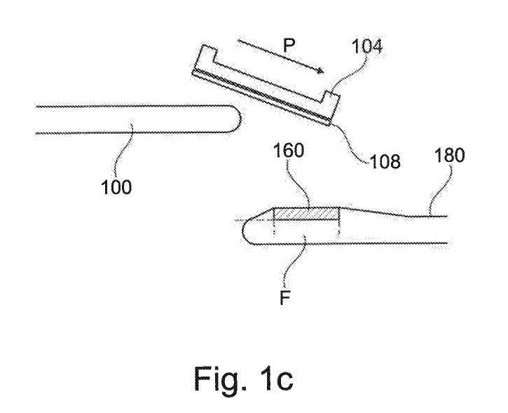

In FIG. 1a, a first and a second conveyor section 100, 102 arranged at a mutual angle in a vertical plane are illustrated. The conveyor sections 100, 102 preferably each comprise a frame F supporting an endless belt 180 for engaging a bottom surface of a tote 104 being transported from the left to the right as indicated by 20 the arrow P. As will be seen in FIG. 1b the tote 104 will tilt upon moving from one conveyor section to the next, with the front part of the tote impacting the endless belt 180 of the downstream conveyor section 102 in an item transition region T. While in FIGS. 1a and 1b the tote 104 is conveyed from left to right the tote 104 may alternatively be conveyed in the opposite direction for which case the invention to be described below may also find use by providing shock-absorption to the first conveyor section 100.

Shown in FIG. 1c is an alternative embodiment of the conveyor system wherein the totes 104 fall freely from the first conveyor section 100 onto an endless conveyor belt 180 supported by a frame F of a downstream or second conveyor section.

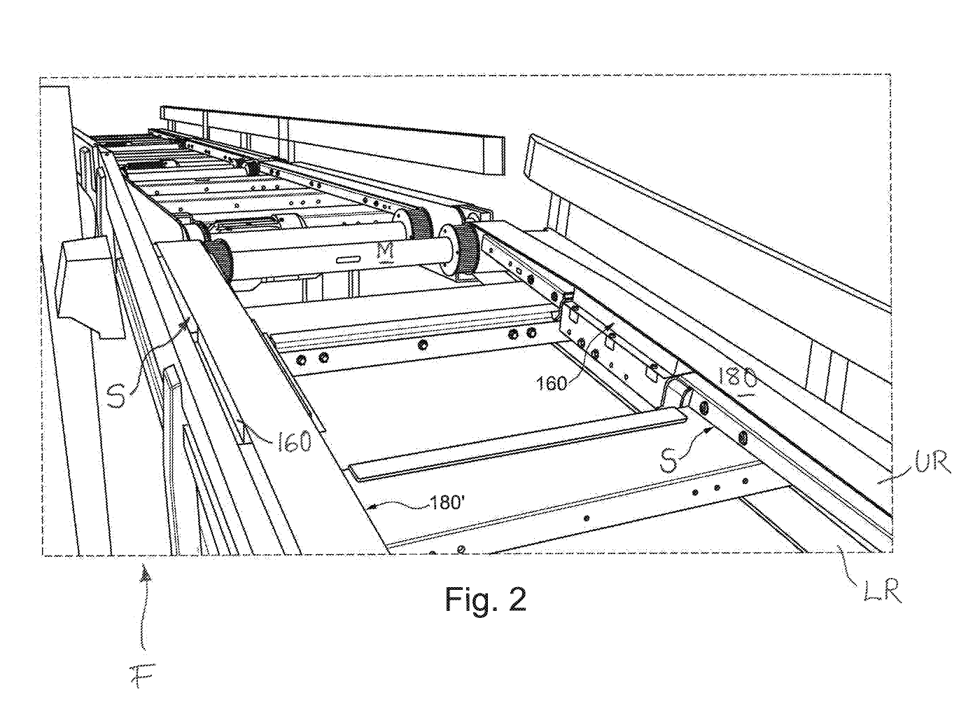

Common to the aforementioned embodiments is a shock-absorbing device 160 located below the conveyor belt 180 in the item transition region T and that has an upper surface configured to contact the lower surface of the conveyor belt 180, at least on the tote 104 impacting the conveyor belt 180, either as it tilts or falls freely onto the second conveyor section 102. The conveyor belt 180 may be in continuous contact with the shock-absorbing device 160 during operation of the conveyor system, as schematically shown in FIG. 1c and in FIGS. 2-5 to be discussed below. However, the shock-absorbing device 160 may also be arranged at a distance below the lower surface of the conveyor belt 180 such that contact only occurs on the aforementioned impact.

FIG. 2 is a perspective view of the conveyor system of fig. la and showing the frame F thereof as including vertical support pillars and two spaced apart elongated parallel beams S interconnected by metal profiles and carrying driven rollers (M) with motors for driving two spaced apart conveyor belts 180, 180′. The conveyor belts 180, 180′ are each formed as an endless loop, with an upper run UR and a lower run LR and with the respective beam S extending between the upper run UR and lower run LR and being connected to the support pillars. A tote (not shown) is moved forward by the bottom edges of the tote 104 resting on the upper surface of the upper run UR of a respective one of the two conveyor belts 180, 180′. For the sake of ease the term conveyor belt as used below refers to the upper run UR which has a lower surface facing the respective beam S. A shock-absorbing device 160 as mentioned before is mounted to each beam S and has an upper surface against which the lower surface of the conveyor belt 180, i.e. of the upper run UR, slides. Where only a single conveyor belt 180 is used, spanning between the beams S, the shock-absorbing device 160 may be mounted eg. on the interconnecting profiles between the beams S.

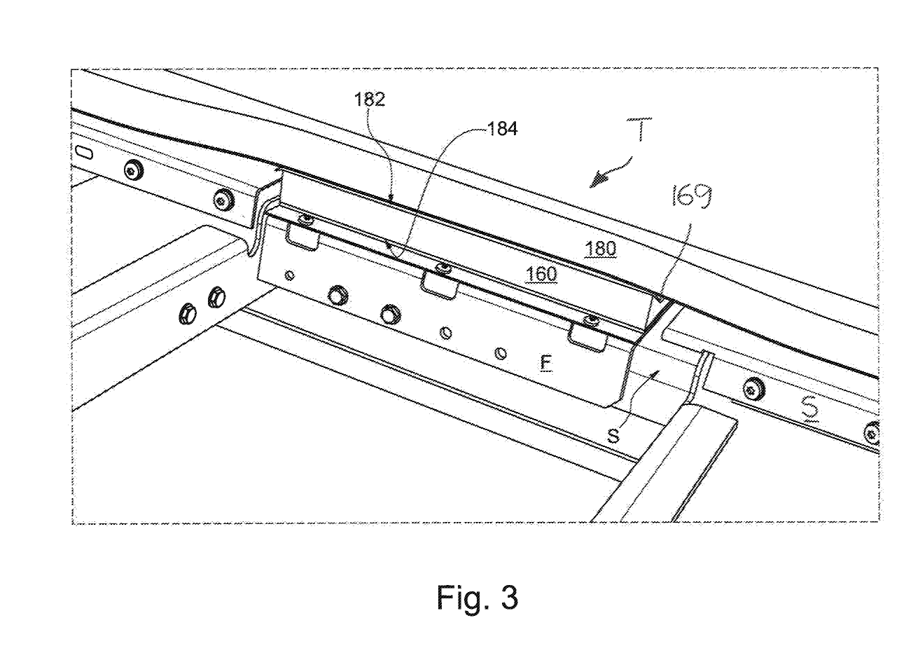

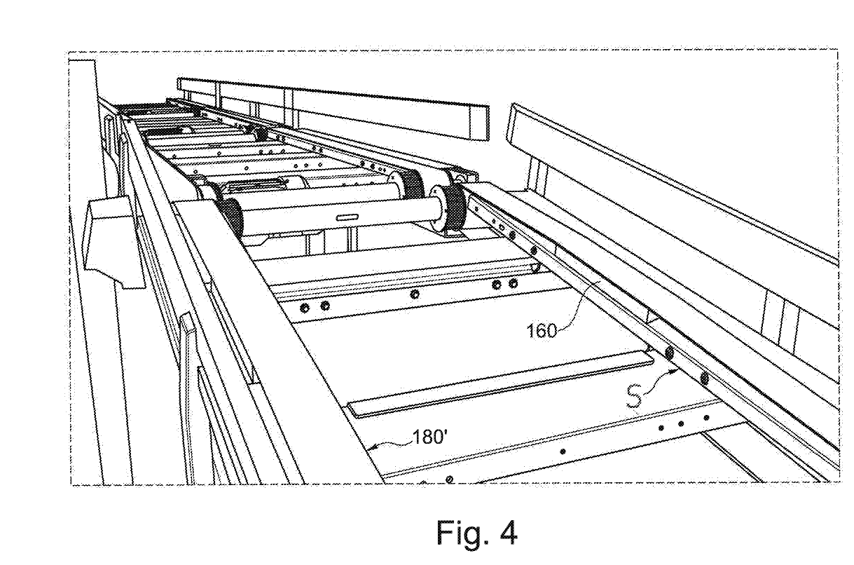

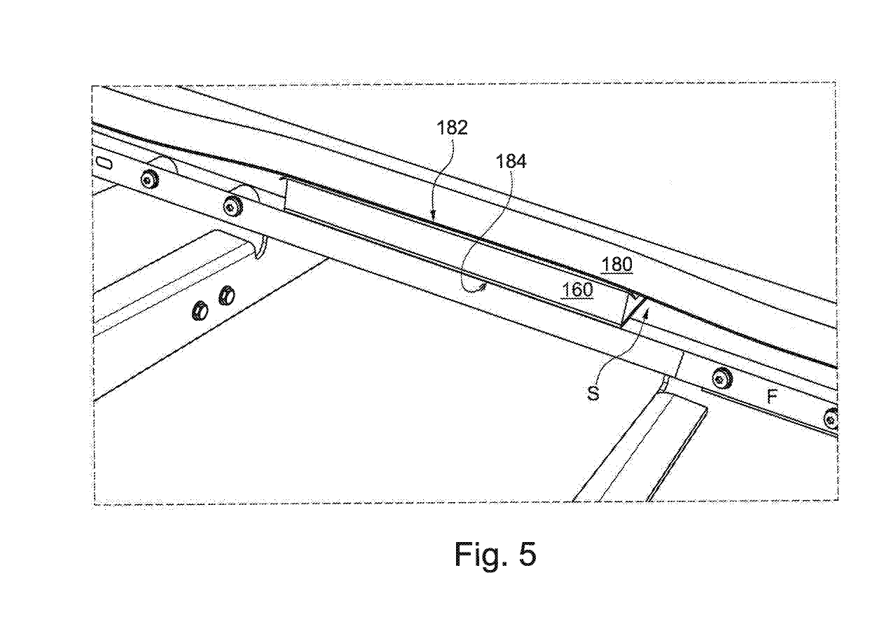

As shown in FIG. 1c and FIGS. 2-5 the shock-absorbing device 160 is preferably configured as an elongated block of a resilient material which may locally raise the conveyor belt 180 a distance from the beams S in the item transition region T, with the resilient material of the device 160 being continuously held in a state of compression through the tension in the conveyor belt 180 acting thereon. The shock-absorbing device 160 may alternatively be arranged to contact the conveyor belt 180, 180′, i.e. the lower surface of the upper run UR, only when a tote 104 impacts the conveyor belt 180, 180′ in the item transition region T, i.e. such that there is only sliding contact with the shock-absorbing device 160 on that occasion. FIG. 3 shows an embodiment where the beams S have an aperture or recess receiving the shock-absorbing device 160 in such a manner that a top portion thereof including the upper face 182 contacting the lower surface of the upper run UR of the conveyor belt 180 projects upwardly from the beam S; in another embodiment shown in FIGS. 4 and 5 the shock-absorbing device 160 is fixed with a first or lower face 184 thereof bearing flatly against the upper flange of the beams S.

While in principle any type of shock-absorber may be used a shock-absorbing device 160 formed simply as a block of a shock-absorbing material, such as a rubber material or a foamed material, possibly with any inlays, providing a damping by compression is preferred. Since, at least at the time when the tote 104 impacts the conveyor belt 180, the lower surface of the moving conveyor belt 180 will slide against the upper face 182 of the block 160, it is preferred to form the shock-absorbing device 160 with a low friction material layer 169 which forms the aforementioned upper face 182, as shown in FIG. 3. As an alternative the shock-absorbing device 160 may include an upper wheel structure (not shown) which defines the portion contacting the lower surface of the upper run UR and which is mounted to the beams S; such a solution may reduce surface wear but may on the other hand require mechanical connections between the wheel structure and the shock-absorbing portion, unless the wheel as such provides the required damping.

1. A conveyor system for transporting items in a conveying direction and comprising:
a first conveyor section,
a second conveyor section, and
a frame below said second conveyor section,
said first conveyor section and said second conveyor section each defining a conveying surface for engaging a bottom surface of said items and for forward movement of said items along said conveying direction,
said first conveyor section being adapted to deliver one or more of said items to an item transition region of said second conveyor section,
said second conveyor section including:
at least one conveyor belt defining said conveying surface of said second conveyor, and
a shock-absorbing device mounted to said frame in said item transition region, wherein
said shock-absorbing device comprises an upper face located below said at least one conveyor belt and facing said conveyor belt, and
said shock-absorbing device is configured to provide a controlled vertical deceleration of said items in said transition region by said conveyor belt being pressed against said upper face by impact applied by said items onto said conveyor belt in said transition region.

2-15. (canceled)

16. The conveyor system of claim 1, wherein said item transition region is at a lower level than said first conveyor section.

17. The conveyor system of claim 1, wherein said frame comprises at least one elongated beam extending along with and below said conveyor belt and, wherein said beam carries said shock-absorbing device.

18. The conveyor system according to claim 17, wherein said second conveyor comprises at least two spaced apart parallel conveyor belts defining together said conveying surface of said second conveyor, an elongated beam extending along with and below each of said conveyor belts, a respective one of said shock-absorbing devices being mounted to each of said beams in said item transition region, with said upper face thereof facing the corresponding conveyor belt above said beam, so as to provide for a continuous contact between said upper face of said shock-absorbing device and said conveyor belt.

19. The conveyor system according to claim 17, wherein said elongated beam comprises a recess configured to receive said shock-absorbing device, so as to provide for a continuous contact between the upper face of said shock-absorbing device and said conveyor belt.

20. The conveyor system according to claim 1, wherein said system is configured such that said conveyor belt is in sliding contact with said upper face in said transition region, at least on said impact.

21. The conveyor system according to claim 1, wherein said shock-absorbing device comprises a compressible block that comprises a resilient material and a first side and an opposite second side defining said upper face.

22. The conveyor system according to claim 21, wherein said block is elongated and having a largest dimension in a direction along said conveyor belt.

23. The conveyor system according to claim 22, wherein said block comprises a rubber material or a foamed material.

24. The conveyor system according to claim 21, wherein a material layer of said block, defines said upper face and provides a relatively low frictional resistance to said conveyor belt.

25. The conveyor system according to claim 21, wherein a material layer of said block is a metal material layer, defining said upper face and providing a relatively low frictional resistance to said conveyor belt.

26. The conveyor system according to claim 1, wherein said device comprises an inflatable portion.

27. The conveyor system according to claim 1, wherein said first conveyor section and said second conveyor section define a mutual angle in a vertical plane extending in parallel to said conveying direction.

28. The conveyor system according to claim 1, wherein said shock-absorbing device is continuously held in a state of compression by said conveyor belt.

29. The conveyor system according to claim 1, wherein said upper face of said shock-absorbing device contacting said conveyor belt only on said impact.

30. The conveyor system according to claim 1, wherein said shock-absorbing device comprises a roller defining said upper face.

31. The conveyor system according to claim 19, wherein said shock-absorbing device is a compressible shock-absorbing device.

32. The conveyor system according to claim 30, wherein said shock-absorbing device is a compressible shock-absorbing device.
